(19) United States
(12) Patent Application Publication
(10) Pub. No.: US 2005/0154728 A1
(43) Pub. Date: Jul. 14, 2005

(54) Notification of access for a sender of an electronic message

(76) Inventor: Michael Greve, Karlsruhe (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/508,076

(22) PCT Filed: Oct. 14, 2003
(86) PCT No.: PCT/EP03/11355

(30) Foreign Application Priority Data
Oct. 15, 2002 (DE) 102 48 088.5
Nov. 14, 2002 (DE) 102 53 175.7

(51) Int. Cl. G06F 17/30

(52) U.S. Cl. 707/9

(57) ABSTRACT

A method for notifying a sender of an electronic message to a recipient that the recipient has accessed the electronic message includes integrating data into the electronic message so as to associate message identification data with the electronic message before the electronic message is accessed. An access to the electronic message is detected by detecting an access to the integrated data. An access notification is provided to the sender indicating the access to the electronic message.

### BACKGROUND OF THE INVENTION

The present invention relates to means for informing a sender of an electronic message that a recipient intended to receive the electronic message has actually accessed this message.

### BACKGROUND OF THE INVENTION

Electronic messages, such as so-called “e-mails”, are used for exchanging information between technical systems, units, apparatuses, devices, and the like. In particular, electronic messages are used for exchanging information between end user units, such as stationary or mobile computer systems, in particular personal computers, mobile computers (laptops, handhelds, etc.), stationary and mobile telephones, pagers, and the like. In order to use an electronic message, the electronic message, for example, after entering a message text, is transmitted by an end user unit of a sender to an end user unit of a recepient intended to receive the electronic message. Message transmission is over one or more networks (such as the Internet, cellular networks, mobile telephone systems, etc.); a unique address of the intended recipient (for example, an e-mail address) associated with the electronic message ensuring that the message is transmitted to this recipient. Network transmission is usually via one or more interposed computer systems (such as network servers, gateways, routers, network nodes, etc.).

The sent electronic message is stored in a network used for transmission, a computer system used in such a network, the end user unit of the user intended as the recipient, and the like, or, in the case of an e-mail, in a so-called “mailbox”. This storage corresponds to the reception of the electronic message by the intended recipient, which is comparable to the delivery of a letter by placing it into a mailbox. In this connection, it is known to notify the end user unit of the receipt of the electronic message, over the same transmission path that was used to transmit the electronic message. In the case of an electronic message sent in the form an e-mail, this is usually accomplished by sending an e-mail indicating the receipt back to the end user unit of the sender.

This state, i.e., the receipt or the delivery of the electronic message, does not say whether the intended recipient has actually accessed the electronic message, i.e., whether, for example, the intended recipient has opened, read, or otherwise used the electronic message. In order for the intended recipient to actually access the electronic message, the recipient accesses the stored electronic message; the electronic message, unless it is already stored in the end user unit of the intended recipient, being transferred thereto, and available there for use in a suitable manner. It is only when the intended recipient actually uses the electronic message, for example, by opening it to read texts, view pictures, or the like, that the intended recipient has actually accessed the electronic message. To inform the sender of the electronic message that the intended recipient has actually accessed the electronic message, it is known that when the end user unit of the intended recipient actually accesses an electronic message, it informs the sending end user unit of this over the transmission path that was used to transmit the electronic message. Such an access notification can be transmitted by a receiving end user unit to the respective sending user units automatically for each electronic message, or depending on whether a sending user unit has requested such an access notification.

The known approaches for notifying a sender of an electronic message that this message has actually been accessed by an intended recipient have the problem that the sending and receiving end user units often have to meet predetermined requirements to allow an access notification to be generated and/or returned. Examples of this are e-mail programs used for transmitting electronic e-mail messages. In the case of these e-mail programs, it is generally required that both the sending and the receiving und user units use the same e-mail program or at least compatible e-mail programs to effectively transmit an access notification request from the sending end user unit to the receiving end user unit. In one commercially available e-mail program, the access notification request is transmitted in a so-called “X-header” with a corresponding e-mail. The e-mail program of the receiving end user unit then interprets the X-header information in order to return an access notification to the sending end user unit when the intended recipient actually accesses the e-mail. If this e-mail program transmits an e-mail to an end user unit that uses a different e-mail program, it is not guaranteed that the X-header information characterizing the access notification requests are/can be interpreted by the receiving end user unit so as to generate and/or return the desired access notification.

A further problem of known approaches for access notifications is that usually a sender receives an access notification only if the end user unit used for sending an electronic message is in operation or at least operational. Otherwise, the sender can receive an access notification in a manner perceptible to him/her only when the und user unit used for sending is returned to operation. In such cases, therefore, the sender cannot receive an access notification immediately when an access to the sent electronic message actually takes place. In this connection, moreover, there is often the problem that access notifications are lost, i.e. are not provided to a particular sender, if the end user unit used for sending is not in operation when the access notification is transmitted by a receiving end user unit.

Document WO 00/33203 discloses a method where a sender of an e-mail is informed that a server that received the e-mail from the sender has transmitted the e-mail to a recipient.

United States Patent Application No. 2002/0104026 A1 describes a method where a software application locally present and executed at a recipient's side monitors whether an e-mail transmitted to the recipient is opened. If an e-mail is opened, this is recognized as such by the software application. In response to this, the software application transmits data to a sender of the opened e-mail, this data notifying the sender of the opening.

United States Patent Application No. 2002/0019852 A1 discloses a method where an executable file is added as an attachment to an e-mail of a sender. If the e-mail is opened by a recipient upon receipt, the attached executable file is executed. As a result of the execution of the file, information about the recipient is captured and provided to the sender.

German Patent Application DE 19757915 A1 and World Patent Application WO 01/06748 A1 describe methods for informing a recipient of an e-mail that the e-mail is present. To notify the recipient, different telephone services, voice messages, text messages, and facsimile messages can be used.

### OBJECT OF THE INVENTION

It is an object of the present invention to provide means for informing a sender of an electronic message that an intended recipient has actually accessed the electronic message, this information being provided to the sender reliably and essentially independently of the method and means used to transmit the electronic message to the intended recipient.

### BRIEF DESCRIPTION OF THE INVENTION

To achieve the above object, the present invention provides a method according to claim 1 for notifying, via an access notification, a sender of an electronic message to a recipient that the recipient has accessed the electronic message. In this context, “access to the electronic message” is understood to mean that the recipient uses the electronic message in the way generally dependent on the type of the electronic message; i.e., by reading (text message), viewing (picture/video message), listening (audio/voice message), and the like. Access notifications, as used here, denote all kinds of data/information, messages, and the like, that indicate to the sender that the recipient intended to receive the electronic message has actually accessed this message.

In order to notify the sender, it is detected that the recipient has actually accessed the electronic message; the detection occurring independently of the recipient (i.e., without the recipient being able to influence this, and/or independently of the software and/or hardware components used for access). If such an access is detected, the access notification is generated, also independently of the recipient.

Due to the recipient-independent steps for detecting an actual access to the electronic message and generating a corresponding access notification, the sender can be reliably notified of the access. Moreover, it is thus no longer necessary for the sender and/or the recipient to carry out certain technical requirements and/or certain steps in order for the sender to be notified.

According to the present invention, this is achieved by associating message identification data with the electronic message before this message is accessed. The message identification data, for example, in the form of a unique identification number or identifier, characterize the electronic message. When the electronic message is accessed, it is detected, based on the message identification data, that the electronic message has just been accessed, and a corresponding access notification can be generated.

For associating the message identification data, data is integrated into the electronic message.

Access to the electronic message using the message identification data is detected in that, when the electronic message is accessed, the data integrated in the electronic message is accessed as well. Due to the inventive association of the message identification data with the electronic message, access to the electronic message and the associated access to the integrated data causes the message identification data to be accessed as well. Therefore, the fact that the message identification data has been accessed clearly indicates that the electronic message itself has been accessed.

It is possible to transmit access notification request data along with the electronic message; the access notification request data indicating that the sender is to be informed of the access to the electronic messages. This allows the sender to request or not to request access notifications, for example, depending on the type of a sent electronic message and/or or an intended recipient. To transmit access notification request data with an electronic message, it is possible, for example, to select a corresponding option when-using an e-mail software program.

Preferably, notification destination data is transmitted with the electronic message; the notification destination data indicating a destination to which the access notification is to be transmitted. The notification destination data may specify the sender address itself if the access notification is to be returned thereto. However, the notification destination data also allows specification of a different destination, for example in the form of a telephone number, an e-mail address, or a postal address, to which the access notification is to be transmitted. This allows the sender to send the electronic message, for example, using a computer, and to specify via the notification destination data that the access notification is to be transmitted, for example, to a mobile telephone via an SMS.

In place of the notification destination data, data otherwise specified by the recipient can also be used to indicate the destination to which the access notification is to be transmitted. In the case of an e-mail system, this can be accomplished, for example, by the sender specifying to his/her e-mail provider one or more destinations to which access notifications are to be transmitted.

Accordingly, the access notification can be provided to the sender as an electronic access notification to an end user unit used for sending the electronic message, as an electronic access notification to a different end user unit specified by the sender, or in non-electronic form, with or without using the notification destination data. Examples of electronic and non-electronic access notifications are defined further below.

In a preferred embodiment, which is especially suitable for use with e-mail systems in which electronic messages are (temporarily) stored by a computer system of an e-mail provider, the recipient accesses the electronic message in response to data indicating the transmission of the electronic message to the recipient.

The integration of the data into the electronic message is preferably carried out in such a way that the electronic message itself is not altered, or at least that it is complemented in a manner imperceptible to the recipient; i.e., retaining the content of the electronic message.

In a particularly preferred embodiment, pixel GIF data is integrated into the electronic message as message identification data.

To detect access to the message identification data, it is proposed to transmit the message identification data to the recipient before the recipient can use it. This can be accomplished, for example, in that the message identification data is not immediately accessed when accessing the electronic message, but a request causing the transmission of the message identification data is transmitted from the recipient in response to an access to the electronic message.

In further preferred embodiments, a transmission device used for transmitting electronic messages and located between the sender and the recipient is used. The transmission device is able to detect the access to the electronic message, to associate the message identification data with the electronic message, to detect the access to the electronic message based on an access to the message identification data, in particular, based on a transmission to the recipient, and to generate and transmit the access notification. Moreover, the transmission unit is able to generate and transmit data indicating to the recipient that the sender has sent an electronic message to the recipient. The transmission devices provided for this purpose are, for example, computer systems of an e-mail provider, of a mobile radio provider, and the like.

End user units, such as stationary or mobile telephones, stationary or mobile computer systems, SMS transmitter/receiver units, pagers, and the like, can be used to transmit and/or access the electronic message. For this, it is proposed that the sender use a first end user unit while the recipient can use a second end user unit.

As explained above, the access notification can be returned to the sender address itself; i.e., in this case to the first end user unit. To provide the access notification to the sender also in a different way and/or at a different place, the sender can define a third end user unit to which the access notification is to be transmitted.

The access notification can be generated using voice messages, SMS messages, pager messages, e-mail messages, WAP e-mail messages, facsimile messages, and telex messages, mainly depending on the sender, and in particular on an end user unit which is associated with the sender and to which the access notification is to be transmitted. These access notifications, which are comparable to an electronic message, allow the sender to be quickly and reliably informed of the access to his/her electronic message. If, after sending the electronic message, the sender cannot receive an access notification in electronic form, for example, because he/she is on vacation, the access notification can also be transmitted using a letter or a postcard.

To transmit the access notification, it is proposed to use stationary and/or mobile telephone networks, radio systems, local computer networks, the Internet, SMS transmission systems, satellite-based transmission systems, and conventional postal services.

Moreover, to achieve the objective in question, the present invention provides a transmission device, a communications system, and software program products.

### BRIEF DESCRIPTION OF THE DRAWING

In the following description of preferred embodiments, reference is made to the accompanying FIGURE, which illustrates the method according to the present invention.

### DESCRIPTION OF PREFERRED EMBODIMENTS

In the following, preferred embodiments will be explained using the example of an electronic message in the form of an e-mail that is sent from a sender 2, or a first user unit 2 associated with the sender, via a transmission device 16, such as an e-mail server, to a recipient 6, or a second end user unit 6 associated with the recipient.

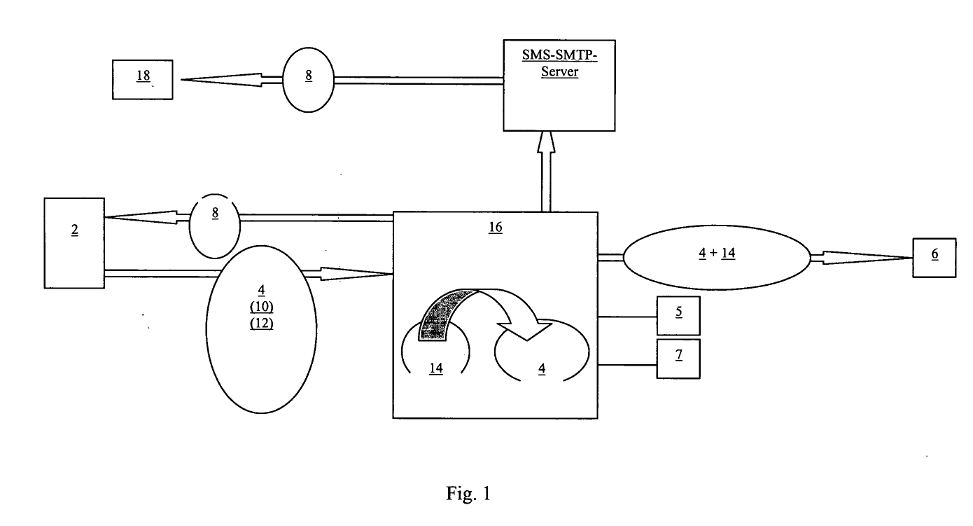

As illustrated in FIG. 1, an electronic message 4 that is composed by a sender 2 and addressed to a recipient 6 is transmitted from sender 2 to a transmission device 16. An access notification request 10 and/or notification destination data 12 can be transmitted in addition to electronic message 4, i.e., as further electronic messages or embedded in electronic message 4.

Access notification request 10 indicates to transmission device 16 that sender 2 wishes to be informed that recipient 6 has actually accessed electronic message 4. In the selected example of an e-mail as the electronic message 4, “access” means that recipient 6 has actually opened the e-mail to read it. The transmission of access notification request 10 may be omitted if sender 2 is always to be informed that electronic messages 4 created by him/her have been accessed. This can be stored, for example, in a database (not shown) associated with transmission device 16.

Using notification destination data 12, sender 2 can inform transmission device 16 of the destination to which the requested access notification 8 is to be transmitted. This allows sender 2, for example, to create an electronic message 4 using his/her personal computer, but to indicate via notification destination data 12 that the requested access notification 8 is to be transmitted to a telephone, for example, in the form of an SMS or a voice message. In this case, notification destination data 12 would indicate a suitable telephone number. If no notification destination data 12 is transmitted with electronic message 4, it is proposed that a database (not shown) associated with transmission device 16 be used, in which at least one destination defined by sender 2 is stored, to which the requested access notification 8 is to be transmitted. When using a plurality of access notification destinations, it is proposed to select the destination to which the requested access notification 8 can be transmitted in the quickest way possible. Moreover, the use of a plurality of access notification destinations allows the requested access notification 8 to be transmitted to a destination that can be reached by transmission device 16 at the time the access notification 8 is transmitted, for example, a telephone that is switched on.

Transmission device 16 associates message identification data 14 with electronic message 4; the message identification data uniquely characterizing electronic message 4. In the case of an electronic message 4 in the form of an e-mail, this association is accomplished by adding or embedding message identification data 14, here in the form of a pixel GIF.

If transmission device 16 does not transmit electronic message 4 to recipient 6 immediately, the transmission device 16 stores the electronic message in such a way that it is uniquely associated with recipient 6, for example, in-a mailbox (not shown) associated with recipient 6. In the latter case, transmission device 16 transmits electronic message 4 to recipient 6 in response to a corresponding request transmitted by the recipient.

When recipient 6 actually accesses electronic message 4, i.e., in this case, when he/she opens the e-mail of sender 2, the message identification data 14 is accessed as well. In this case, this means that message identification data 14 is retrieved from transmission device 16 in the form of a pixel GIF. This clearly indicates that recipient 6, after receiving electronic message 4, has actually accessed this message; i.e., reads the e-mail.

The use of message identification data 14 in the form of pixel GIFs is proposed especially in conjunction with HTML-formatted e-mails; the use of an HTML-capable receiver contributing in making it possible that, when accessing an electronic message 4, the access to associated message identification data 14 can be detected based on transmission of the same to recipient 6.

In response to recipient 6 accessing electronic message 4, transmission device 16 generates a notification 8 of this. Access notification 8 can be an electronic message in the form of an e-mail or an SMS message addressed to sender 2. The type of access notification 8 depends, inter alia, on the destination intended for the transmission of access notification 8, for example, based on notification destination data 12.

In the case of an access notification 8 in the form of an SMS message, transmission device 16 causes transmission via a suitable device, such as an SMS-SMTP server. This device then sends access notification 8 using a telephone number that is specified by notification destination data 12 or stored in the database, and which sender 2 has specified as the destination to which access notification 8 is to be transmitted.

The use of access notifications 8 in a form differing from that of an electronic message 4 sent by sender 2 has the advantage that sender 2 can be informed of the actual access to an electronic message 4 independently of the device he/she used to compose this message. Thus, for example, it is possible for sender 2 to send an electronic message 4 using his/her personal computer, and to be informed via an SMS message of an access to electronic message 4, independently of whether or not his/her personal computer is in operation.

1-29. (canceled)

30. A method for notifying a sender of an electronic message to a recipient that the recipient has accessed the electronic message, the method comprising:
integrating first data into the electronic message so as to associate message identification data with the electronic message before the electronic message is accessed, the electronic message identification data characterizing the electronic message;
detecting an access to the electronic message by detecting an access to the integrated first data; and
providing an access notification to the sender indicating the access to the electronic message.

31. The method as recited in claim 30 wherein the access to the integrated first data is dependent on the access to the electronic message.

32. The method as recited in claim 30 further comprising transmitting access notification request data with the electronic message, the access notification request data indicating that the sender is to be informed when the electronic message is accessed.

33. The method as recited in claim 30 wherein the providing includes transmitting the access notification to the sender and further comprising transmitting notification destination data with the electronic message, the notification destination data characterizing a destination to which the access notification is to be transmitted.

34. The method as recited in claim 30 wherein the providing is performed using at least one of:
an electronic access notification to an end user unit used for sending the electronic message;
an electronic access notification to a different end user unit specified by the sender; and
a non-electronic notification.

35. The method as recited in claim 30 wherein the access to the electronic message is performed in response to transmission data received by the recipient, the transmission data indicating a transmission of the electronic message to the recipient.

36. The method as recited in claim 30 wherein the integrating is performed so to retain a content of the electronic message.

37. The method as recited in claim 30 wherein the first data includes pixel GIF data.

38. The method as recited in claim 30 wherein the detecting an access to the integrated first data is performed using a transmission of the message identification data to the recipient in response to the access to the integrated first data.

39. The method as recited in claim 30 wherein the integrating is performed using a transmission device used for transmitting the electronic message to the recipient.

40. The method as recited in 39 wherein the detecting an access to the electronic message is performed using the transmission device.

41. The method as recited in claim 40 wherein the detecting an access to the electronic message data is performed using the transmission device.

42. The method as recited in claim 39 further comprising transmitting the message identification data from the transmission device to the recipient in response to the access to the integrated first data.

43. The method as recited in claim 39 further comprising generating the access notification using the transmission device.

44. The method as recited in claim 39 wherein the providing includes transmitting the access notification to the recipient using the transmission device.

45. The method as recited in claim 39 wherein the transmission device includes a computer system of an e-mail provider.

46. The method as recited in claim 30 wherein the sender of the electronic message transmits the electronic message using a first end user unit associated with the sender.

47. The method as recited in claim 30 wherein the access is performed using a second end user unit associated with the recipient.

48. The method as recited in claim 46 wherein the providing includes transmitting the access notification to the first end user unit.

49. The method as recited in claim 47 wherein the providing includes transmitting the access notification to a first end user unit associated with the sender.

50. The method as recited in claim 30 wherein the providing includes transmitting the access notification to a third end user unit specified by the sender.

51. The method as recited in claim 50 further comprising storing in a database data indicating the third end user unit.

52. The method as recited in claim 46 wherein the first end user unit includes at least one of a stationary or portable computer, a fixed-network telephone, a fax machine, a mobile telephone, an SMS-capable transmitter or receiver, and a pager.

53. The method as recited in claim 47 wherein the second end user unit includes at least one of a stationary or portable computer, a fixed-network telephone, a fax machine, a mobile telephone, an SMS-capable transmitter or receiver, and a pager.

54. The method as recited in claim 50 wherein the third end user unit includes at least one of a stationary or portable computer, a fixed-network telephone, a fax machine, a mobile telephone, an SMS-capable transmitter or receiver, and a pager.

55. The method as recited in claim 30 further comprising generating the access notification using at least one of an SMS, a voice message, a pager message, an e-mail message, a WAP e-mail message, a facsimile, a telex, a letter and a postcard.

56. The method as recited in claim 30 wherein the providing includes transmitting the access notification using at least one of a stationary telephone network, a mobile telephone network, a radio system, a local computer network, an internet, an SMS transmission system, a satellite-based transmission system, and a postal service.

57. A transmission device for transmitting an electronic message from a first end user unit to a second end user unit, the transmission device including a computing device configured to:
integrate first data into the electronic message so as to associate message identification data with the electronic message before the electronic message is accessed, the electronic message identification data characterizing the electronic message;
detect an access to the electronic message by detecting an access to the integrated first data; and
provide an access notification to the sender indicating the access to the electronic message.

58. The transmission device as recited in claim 57 wherein the computing device includes an e-mail server.

59. A communications system comprising:
a first end user unit configured to send an electronic message;
a second end user configured to receive the electronic message; and
a transmission device configured to:
transmit the electronic message from the first end user unit to the second end user unit,
integrate first data into the electronic message so as to associate message identification data with the electronic message before the electronic message is accessed, the electronic message identification data characterizing the electronic message;
detect an access to the electronic message by detecting an access to the integrated first data; and
provide an access notification to the sender indicating the access to the electronic message.

60. A computer readable medium having stored thereon computer executable process steps operative to perform a method for notifying a sender of an electronic message to a recipient that the recipient has accessed the electronic message, the method comprising:
integrating first data into the electronic message so as to associate message identification data with the electronic message before the electronic message is accessed, the electronic message identification data characterizing the electronic message;
detecting an access to the electronic message by detecting an access to the integrated first data; and
providing an access notification to the sender indicating the access to the electronic message.

61. The computer readable medium as recited in claim 60 wherein the computer executable steps include operating steps for a computer system of an e-mail provider.
